(19) United States
(12) Patent Application Publication
(10) Pub. No.: US 2007/0112906 A1
(43) Pub. Date: May 17, 2007

(54) Infrastructure for multi-modal multilingual communications devices

(75) Inventors: Zicheng Liu, Bellevue, WA (US); David J. Kurlander, Seattle, WA (US); David W. Williams, Woodinville, WA (US); Michael J. Sinclair, Kirkland, WA (US); Zhengyou Zhang, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/273,987

(22) Filed: Nov. 15, 2005

(51) Int. Cl. G06F 15/16

(52) U.S. Cl. 709/200

(57) ABSTRACT

Infrastructure for a multi-modal multilingual communications device (MMCD) is presented. A communications component is provided that includes wireless and wired IP networks (e.g, LANs, MANs, and WANs, . . . ), as well as cellular and/or wired telecommunications networks for cellular communications. A management component can include software and hardware entities that facilitate the activation, authentication, accounting, updating of the MMCD systems, and synchronization to other entities. Additionally, the management component can facilitate the dissemination of applications, third-party services, and subscription information. An access component (e.g., a web server and interface) facilitates access to one or more of these entities such that administrators and/or users can access aspects of setup, configuration, subscriptions, updates, etc.

### BACKGROUND

The advent of the Internet has served as a catalyst for the convergence of computing power and services in portable computing devices. With the technological advances in handheld and portable devices, there is an ongoing and increasing need to maximize the benefit of these continually emerging technologies. Given the advances in storage and computing power of such portable wireless computing devices, they now are capable of handling many types of disparate data types such as images, video clips, audio data an textual data, for example, which data is typically utilized separately for specific purposes.

The Internet has also advanced internationalization by bringing millions of network users into contact with one another via mobile devices (e.g., cellular telephones), e-mail, websites, etc., some of which can provide a level of textual translation. However, the world is also becoming more mobile. More and more people are traveling for business and pleasure. This presents situations where people are now face-to-face with individuals and/or situations in a foreign country where language barriers can be a problem.

Network operators and providers (both cellular as well as non-cellular) have long realized that mobile communications is the next frontier that can provide huge returns. Accordingly, these companies are spending enormous amounts of money and resources in infrastructure to support the many types of portable devices now in existence and that will be marketed in the future. For example, cellular operators are scrambling to provide the infrastructure which allows a cellular customer to access IP networks (e.g., the Internet) and associated IP services via the cellular network. Thus, a cellular customer can now purchase a cell phone that allows access to multimedia that is available on the Internet. In another example, a cell phone user can also message an IP node (another user) on the Internet, and read e-mail from the user's e-mail provider based on the Internet.

The convergence of technology into a single device continues to stress existing infrastructures as the devices which the networks and services are designed to support continue to evolve. These features and a multitude of other device capabilities require a significant undertaking in infrastructure and support from both the cellular provider, as well as the IP server provider. For example, as devices become more powerful, language translation capabilities can include more robust software and hardware. The devices can also employ emergency location services, function as a personal data assistant, and so on. Accordingly, an infrastructure is needed that supports such multi-capable devices such that customers can exploit the increased computing power to enhance user experience.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject invention includes infrastructure for a multi-modal multilingual communications device (MMCD) in accordance with an innovative aspect of the subject invention.

Accordingly, the invention disclosed and claimed herein, in one aspect thereof, comprises a communications component and a management component. The communications component can include wireless and wired IP networks (e.g., LANs (local area networks), MANs (metropolitan area networks), and WANs (wide area networks), . . . ), as well as cellular and/or wired telecommunications networks. Additionally, this includes the macro networks (e.g., cellular carrier and operator networks, Internet, . . . ) down to wireless access point via which an MMCD can register and connect to an IP network.

The management component can include software and/or hardware entities that facilitate the activation, authentication, accounting, updating of the MMCD systems, and synchronization to other entities. Additionally, the management component can include the dissemination of applications, third-party services, and subscription information. An access component (e.g., a web server and interface) facilitates access to one or more of these entities such that administrators and/or users can access aspects of setup, configuration, subscriptions, updates, etc.

In another aspect of the subject invention, methodologies are provided for activating an MMCD, allowing full operation of an MMCD, automatically adjusting a level of subscription or service based on usage, automatically adjusting a subscription based on usage of a plurality of MMCDs, updating device and/or related system software, synchronizing data of an MMCD, installing third-party applications, and employing third-party hardware in an MMCD and/or related system.

In yet another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a generalized infrastructure for a multi-modal multilingual communications device (MMCD) in accordance with an innovative aspect of the subject invention.

FIG. 2 illustrates a methodology of providing an infrastructure for a multi-modal multilingual communications device in accordance with an innovative aspect.

FIG. 3 illustrates a block diagram of components that can be employed as part of the management component of FIG. 1 in accordance with another aspect.

FIG. 4 illustrates an exemplary block diagram of the access component of FIG. 3 in accordance with another aspect of the innovation.

FIG. 5 illustrates a methodology of activating an MMCD according to an aspect.

FIG. 6 illustrates a methodology of allowing full operation of an MMCD according to an aspect.

FIG. 7 illustrates a methodology of automatically adjusting a level of subscription based on usage according to an aspect.

FIG. 8 illustrates a methodology of automatically adjusting a subscription based on usage of a plurality of MMCDs according to an aspect.

FIG. 9 illustrates a methodology of updating device and/or related system software according to an innovative aspect.

FIG. 10 illustrates a methodology of synchronizing data of an MMCD according to an aspect.

FIG. 11 illustrates a methodology of installing third-party applications according to an aspect.

FIG. 12 illustrates a methodology of employing third-party hardware in an MMCD and/or related system according to an innovative aspect.

FIG. 13 illustrates a block diagram of an exemplary applications component that can provide application software in accordance with an aspect.

FIG. 14 illustrates an exemplary infrastructure that facilitates MMCD communications and deployment in a local environment in accordance with an innovative aspect.

FIG. 15 illustrates an exemplary infrastructure that facilitates MMCD communications and deployment in a more expansive environment in accordance with an innovative aspect of the invention.

FIG. 16 illustrates a block diagram of a computer operable to execute the disclosed architecture services.

FIG. 17 illustrates a schematic block diagram of an exemplary computing environment infrastructure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

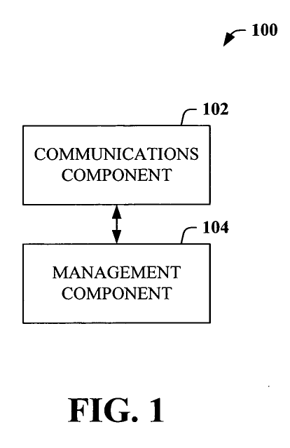

Referring initially to the drawings, FIG. 1 illustrates a generalized infrastructure 100 for a multi-modal multilingual communications device (MMCD) in accordance with an innovative aspect of the subject invention. The infrastructure 100 can include a communications component 102 and a management component 104. The communications component 102 can include wireless and wired IP networks (e.g., LANs (local area networks), MANs (metropolitan area networks), and WANs (wide area networks), . . . ), as well as cellular and/or wired telecommunications networks. Additionally, this includes macro networks (e.g., cellular carrier and operator networks, Internet, . . . ) down to wireless access points via which an MMCD can register and connect to an IP network.

The management component 104 can include software and/or hardware entities that facilitate the activation, authentication, accounting, updating of the MMCD systems, and synchronization to other entities. Additionally, the management component 104 can include the dissemination of applications, third-party services, and subscription information. An access component (e.g., a web server and interface) facilitates access to one or more of these entities such that administrators and/or users can access aspects of setup, configuration, subscriptions, updates, etc. These aspects are described in greater detail infra.

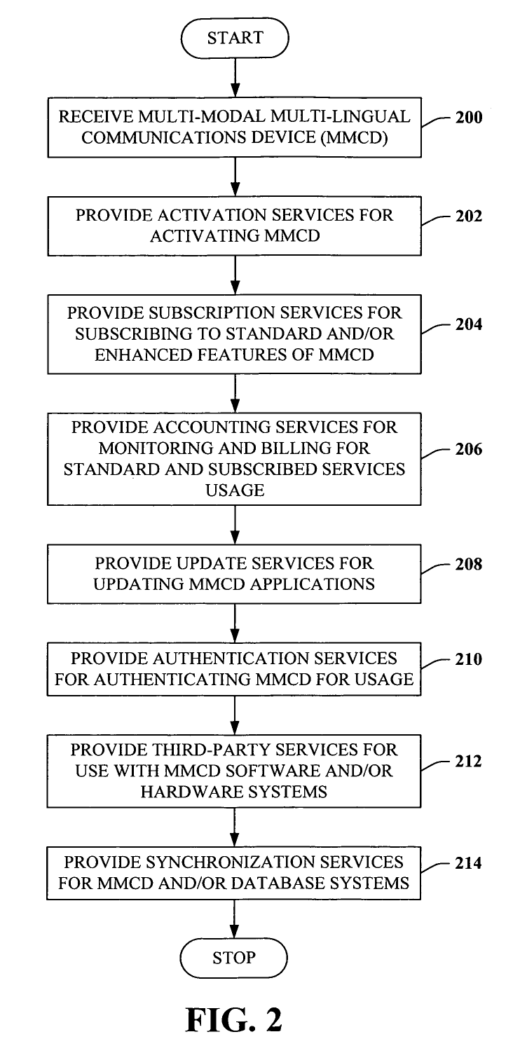

FIG. 2 illustrates a methodology of providing an infrastructure for a multi-modal multilingual communications device in accordance with an innovative aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, an MMCD is received. At 202, activation services are provided for activating the MMCD. At 204, subscription services are provided for subscribing to standard and/or enhanced MMCD features. At 206, accounting services are provided for monitoring and billing for the standard and subscribed services used. At 208, update services are provided for updating MMCD applications and/or hardware drivers, for example. At 210, authentication services are provided for authenticating an MMCD for usage. At 212, third-party services are provided for use with the MMCD software and/or hardware systems. At 214, synchronization services can be provided for synchronization processes of the MMCD and/or database systems.

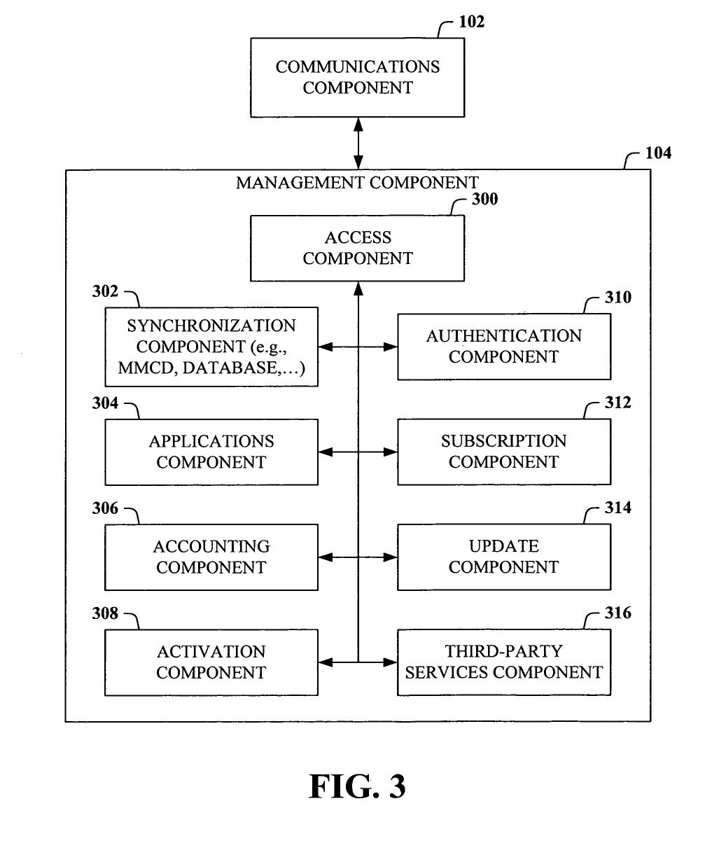

Referring now to FIG. 3, there is illustrated a block diagram of components that can be employed as part of the management component 104 of FIG. 1 in accordance with another aspect. An access component 300 facilitates access to any or all of the management component entities. This can be a web-based operating environment (e.g., .Net by Microsoft Corporation) that allows web-based applications to run such that users can access and interact with other management components.

A synchronization component 302 facilitates synchronization processing of data from various system entities. For example, data captured and stored in a first handheld MMCD can be synchronized with the data of other MMCDs that may be deployed in the field of a commercial environment. This way, all users of the MMCDs who work in a similar environment can have the latest information from which to work. Synchronization can be not only from device to device, but also from device to central or distributed database. For example, at the end of the day, or at other predetermined times, synchronization processing can occur to update applications and/or data on devices and systems throughout the entire infrastructure. In one example, subscription information can be reconciled with accounting information, and so on.

An applications component 304 posts and facilitates the download of applications to MMCDs and/or related systems. For example, where an MMCD includes an image capture component (e.g., a camera), an application that drives the camera can be downloaded into the MMCD. Thus, vendors that provide updates to the application can post the application to the applications component 304 for download to the MMCD or other system entities, as desired.

An accounting component 306 can monitor and track subscriber usage of the MMCD and/or related systems and services. For example, where the MMCD includes voice communications capability over a cellular network, the number of minutes utilized in a given time period can be tracked and processed against the user subscription to check if the user has exceed the allotted minutes for the time period. Accordingly, the user can be charged for the excess minutes. The tracking of other features can also be employed. For example, where the user MMCD employs third-party services and/or applications, the accounting component 306 can monitor and track usage thereof to fulfill licensing requirements, if needed. These are only but a few examples of the capabilities and functions of the accounting component 306 and are not to be construed as limiting in any way.

An activation component 308 facilitates activation of the MMCD and/or related system entities for full subscribed operation. It is to be understood that once the MMCD is purchased, it can be designed to provide only a limited communications capability to facilitate the activation process. Thus, when a user receives the MMCD from a point-of-sale (POS), for example, further interaction can be required to make the unit fully operational in its intended environment. This can include the input and transmission of a user ID or PIN (personal identification number), for example, that once authenticated, fully activates functions of the device for use.

An authentication component 310 allows authentication of the MMCD and/or MMCD user. In an environment where multiple MMCDs are employed, it is desirable that many different users (e.g., employees) can use the same device at any given time. For example, in a restaurant scenario, a first waitress/waiter can use an MMCD to facilitate customer communications. When the shift is over, a second waitress/waiter can then utilize the same device during a second shift. Each user can have different user IDs that automatically enable user preferences which can be stored and/or downloaded into the device. Additionally, where a company uses several different MMCDs in different settings, it is desirable that the MMCDs be sufficiently flexible for use in all of the settings, and not limited in functionality and capability of any given setting. The novel infrastructure provides the system capabilities to utilize any MMCD in any customer environment.

A subscription component 312 tracks and stores user subscription information which can be accessed as part of the authentication, updating, and/or accounting processes, for example. Various levels of subscription (also referred to herein as “levels of service”) can be provided based on the number of MMCDs purchased (or leased), the number of features desired (e.g., number of different language models, number of different input sensors operational, translation capabilities, conversion capabilities, . . . ), and the length of contract and/or licensing, for example.

An update component 314 can facilitate the update and storage of device and system applications and data. The update component 314 can be a website that includes file and/or data storage. Secure access can be provided for user log-in and access, and/or automatic log-in and access by using secure device credentials such as DRM (digital rights management) data, or other unique and secure information. For example, if the MMCD manufacturer generates an update for a device driver this update can be posted to the update component 314 for eventual download to all relevant devices and/or systems. Similarly, if existing applications are updated, the updated applications can be posted to the update component 314 for eventual download to relevant devices and/or systems. It is to be appreciated that any changed data can be posted to the update component 314 for eventual download to an MMCD and/or related infrastructure entity. This also can include data that is uploaded to the update component 314 from an MMCD and/or system entity for storage and/or synchronization to other devices and systems.

A third-party component 316 facilitates the access and/or purchase of third-party products for the MMCD and/or system components. Thus, third-party vendors can provide related hardware and/or software via the component 316. In an alternative implementation, the third-party component 316 operates in combination with the update component 314 and subscription component 312 to ensure that offered third-party products and/or updates are compatible with the intended MMCD and/or related infrastructure entity. For example, where a level of service (or a level of subscription) provides only a limited use of MMCD sensing inputs, it would be incompatible for the purchase and download of a third-party product or service that allows total access of all MMCD sensing inputs. This, coordination with the subscription component 312 can be provided to only activate a subset of the sensing inputs allowed by the level of service under the user subscription plan.

It is to understood that the management component entities can be configured to interact with one another in any desired manner in order to facilitate MMCD operation, account tracking, data synchronization, for example, or any other aspect of providing and maintaining infrastructure services and operations. Moreover, as indicated supra, the access component 300 can facilitate access via the communications component 102 to one or more of the components (302, 304, 306, 308, 310, 312, 314 and 316) by administrators, developers, programmers, and so on for the desired interaction.

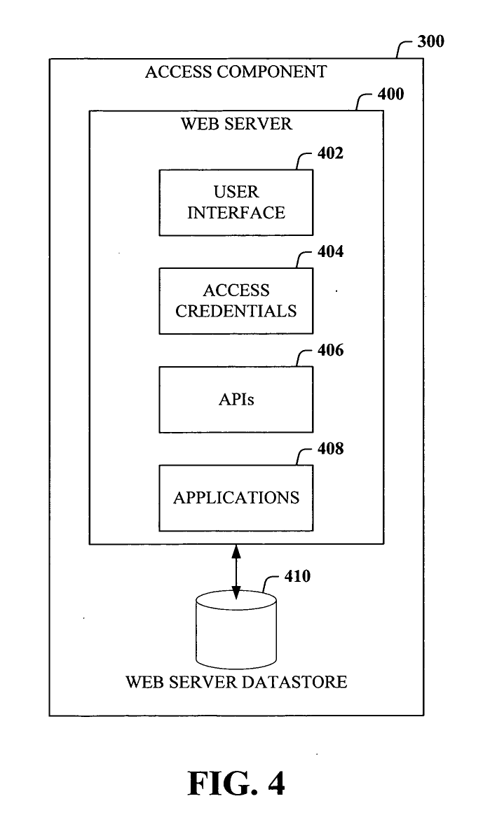

FIG. 4 illustrates an exemplary block diagram of the access component 300 of FIG. 3 in accordance with another aspect of the innovation. The access component 300 can facilitate access to any number of components of the infrastructure, including hardware and/or software. Here, the access component 300 includes a web server 400 through which an authorized user can access many different components. The web server 400 includes a user interface (UI) via which a user interacts to facilitate access to software components of the server 400, and other components that can be disposed on LANs, MANs and/or WANs which serve as part of the infrastructure in support of the MMCDs. The server 400 can also include a security aspect such as access credentials 404 which can include login and password processing, DRM, encryption and any suitable security entities desired for securing access to infrastructure entities.

The web server 400 can also include one or more APIs (application program interfaces) 406 that facilitate user interaction with a software and/or hardware component of the infrastructure. The APIs 406 can include not only those needed for web server access, and infrastructure component access, but also one or more APIs that facilitate interrogation or troubleshooting of an individual MMCD that may be malfunctioning in the field. Thus, troubleshooting can occur to a specific MMCD remotely via the web server 400. In an alternative implementation, the MMCD performs a self test and provides test results or status information to the web server 400 and/or to another infrastructure entity that can be processed to determine the device status. Based on this information, the device can be corrected or pulled from service.

The availability of the APIs 406 also facilitates adding new network services to the infrastructure and, accessing and maintaining those new services. An administrator can simply have a corresponding API written that provides the desired functionality for interfacing and interacting with the new service(s), as can be provided via a new remote web server, or on the web server 400.

The web server 400 can also include one or more applications 408 that can be run directly through the application interface, and/or accessed indirectly through the APIs 406. Thus, the administrator can simply install a compatible application to the web server 400 that provides the desired functionality for interfacing and interacting with the server 400, any existing infrastructure entities, and/or new service(s) and operations, as can be provided via a new remote web server. The web server 400 can also interface to a web server datastore 410 for the storage of data, applications, APIs, UIs, and so on, as desired.

Note that although a single web server 400 is depicted, the access component 300 can comprise many different web servers each of which performs a designated function. For example, a first web server allows access to subscription information, a second web server allows access to update information, a third web server allows access to synchronization software and administration thereof, a fourth web server allows access to accounting information, and so on.

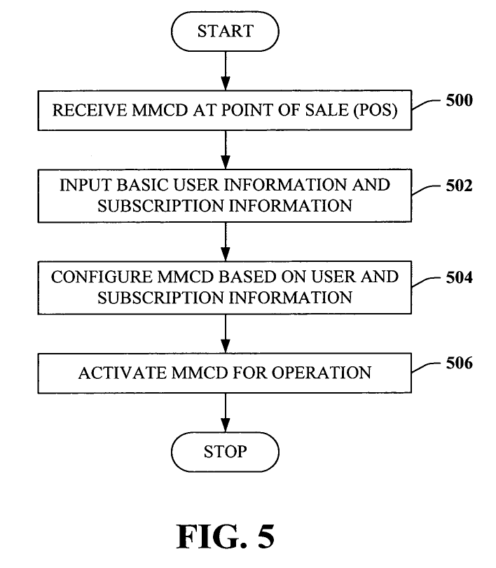

FIG. 5 illustrates a methodology of activating an MMCD according to an aspect. At 500, an MMCD is received at a POS. The POS can be from any retailer, for example. In an alternative example, a customer can purchase MMCDs in bulk for specific commercial uses. Thus, the customer can purchase a set of devices preconfigured for a restaurant business, a taxi cab business, a tour business, and so on. At 502, basic user information and subscription information is entered. This need not be entered into the MMCD itself, although all or part of this information can be entered therein to facilitate operation of the device according to user subscription agreements, but can be entered into a network entity of the infrastructure, for example, the subscription component described supra. At 504, the MMCD can be configured based on the user and/or subscription information. At 506, once the user and/or subscription information is entered into the system, activation of the MMCD can be performed. Activation can be performed at the POS or wirelessly from any other location. If performed remotely, at the user home or business, for example, the MMCD can be provided as operational to a minimal level such that input and transmission of user and/or subscription information can be performed to the desired activating infrastructure entity(ies).

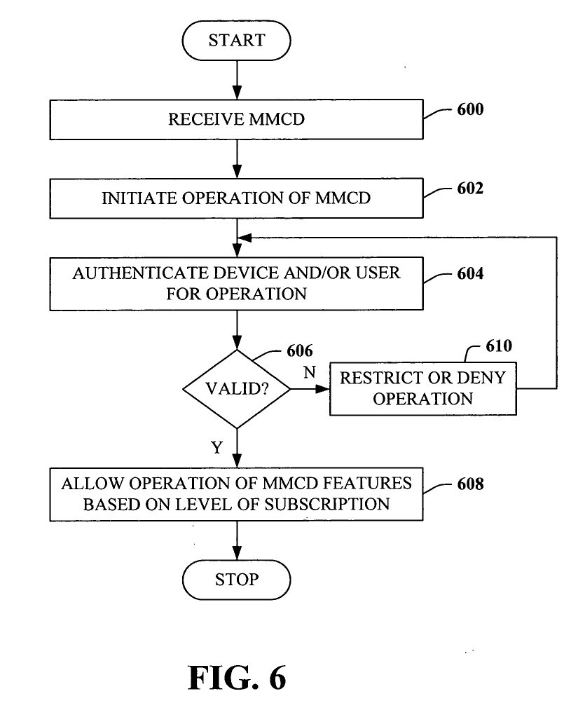

FIG. 6 illustrates a methodology of allowing full operation of an MMCD according to an aspect. At 600, an MMCD is received. At 602, operation of the MMCD is initiated. This can be by simply powering the device, after which a POST (power-on/self-test) like operation is performed that tests basic operation of the device. At 604, authentication can be performed. This can include authentication of the MMCD to the network by communication of a unique device ID which is then processed to determine if the device is allowed to connect to the network. That is, an unauthorized device (e.g., one marked as stolen) will not be allowed access to any services of the network. This can also include authentication of the user to the MMCD. It is to be appreciated that a user/device relationship can be established such that only after entry of the correct user information (e.g., login and password) will the device operate. Incorrect user information can elicit a message that indicates to call a customer support number or access a website, for example, in order to correct the situation. Still further, this can include authenticating both the device and the user to the network. Here, both the unique device ID and the user login information can be communicated to a network entity (e.g., an authentication server) in order to allow operation of the device and some level of access to network services.

At 606, the system tests if the authentication process if valid. If so, at 608, operation of the device and/or access to network services are provided, at some level, based on the level of subscription. At 606, if authentication is not valid, flow is to 610 to restrict access to a reduced level or deny access entirely. Flow is then back to 604 to perform the authentication process again. It is to be appreciated that after a predetermined number of failed authentication attempts, the MMCD can be disabled. Disablement can be for a short period of time (e.g., fifteen minutes) or until the user has called customer service, for example.

The authentication process can also employ other subsystems. For example, an onboard GPS receiver can receive geographic coordinates that define an area in which the device is located. When the user purchases the MMCD or at any time thereafter, information as to the geographic location in which the device will normally be utilized can be input such that when the GPS coordinates indicate that the MMCD is being utilized outside an area of use, the device will be disabled. Many other similar scenarios and other input sensors and/or data can be employed with regards to authentication, such as user speech, gestural, biometrics, environmental, contextual data, and so on.

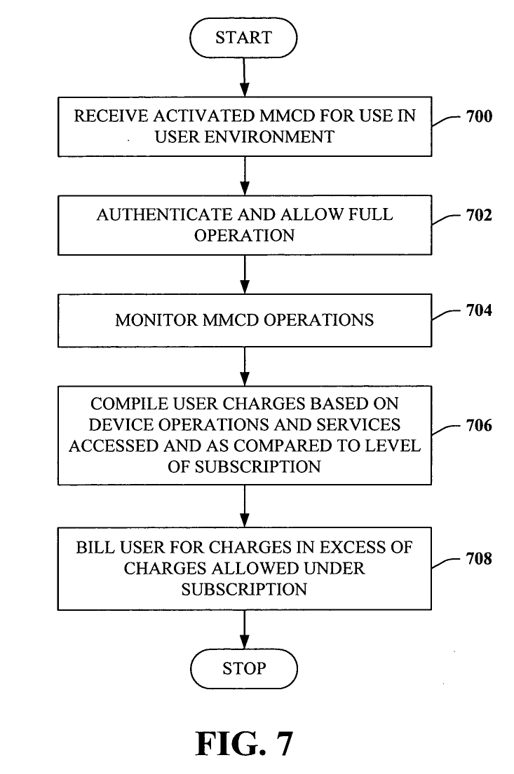

FIG. 7 illustrates a methodology of automatically adjusting a subscription based on usage according to an aspect. At 700, an activated MMCD is received. At 702, the MMCD is authenticated and full functionality allowed according to the subscribed level of functionality. At 704, MMCD operations are monitored according to how the user utilizes device and subscription functions. At 706, user charges can be compiled based on user operations and compared to the user level of subscription. At 708, the user is then billed for any charges in excess of those charges allowed under the level of subscription.

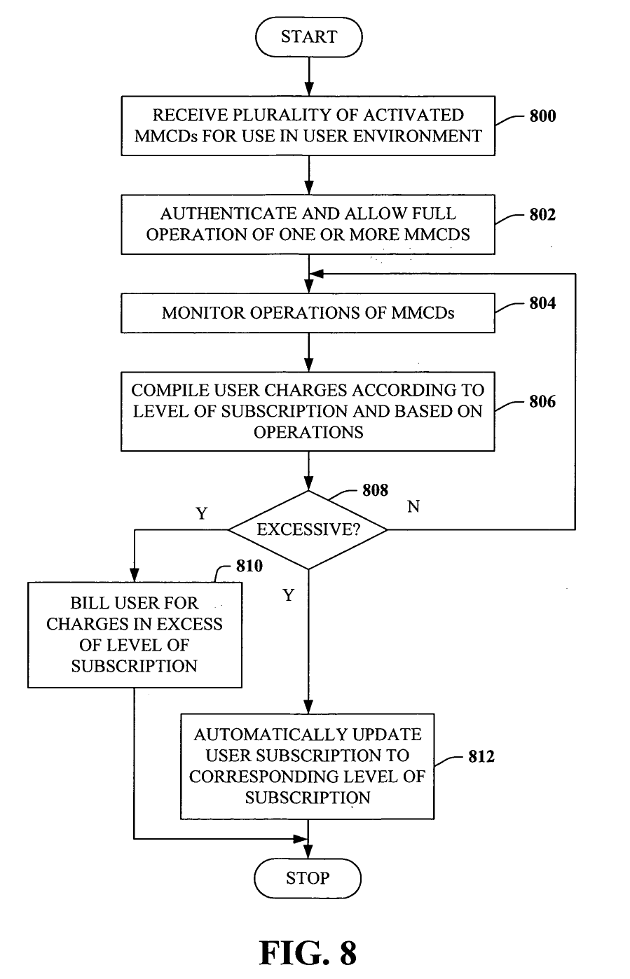

FIG. 8 illustrates a methodology of automatically adjusting a subscription based on usage of a plurality of MMCDs according to an aspect. At 800, a plurality of MMCDs are received and activated for use in a specific environment. At 802, authentication and full operation of the MMCDs is allowed according to the subscribed level of service. At 804, operations of the MMCDs are monitored. At 806, user charges based on the monitored usage are compiled and compared to the subscription level. At 808, the system checks if the charges exceed the allowed subscription level. There are at least two options that the service provider can take. In one path, at 810, the user is billed for the charges in excess of the charges allowed under the subscription plan. Alternatively, at 812, the provider can automatically update or upgrade the user's current level of service to one that corresponds to the current usage of all devices deployed by the user. This alternative path can provide savings to the customer since the upgraded level of service typically will not penalize the user to the extent of excessive usage under the previous plan. At 808, if the existing charges are found to not be excessive, flow can be back to 804 to continue monitoring operations of the deployed devices under the level of service of the user.

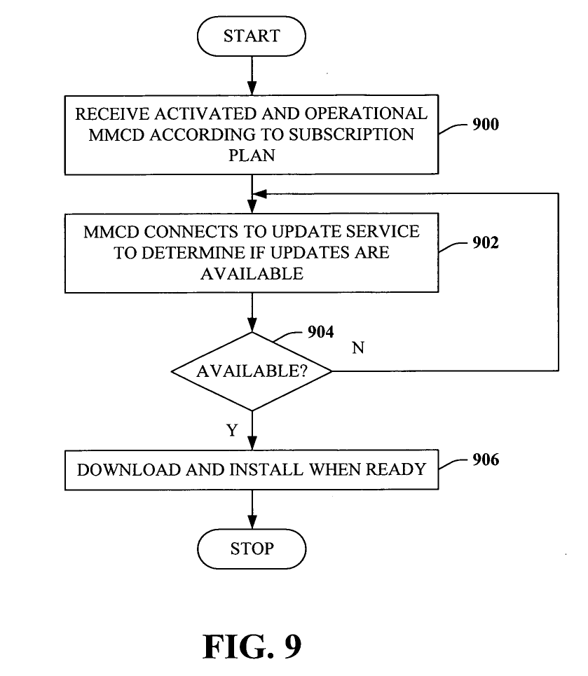

FIG. 9 illustrates a methodology of updating device and/or related system software according to an innovative aspect. At 900, an activated and operational MMCD is received under a level of service. At 902, the MMCD connects to an update service to check for updates related to any software stored on the MMCD. This update process can be initiated manually, or automatically according to an automatic periodic update process. At 904, a check is made to determine if updates are available. This can be accomplished by a data file that tracks all application and/or file versions (e.g., by time and date stamp) being accessed by the update service or being uploaded to the update service as a prelude to checking for updated software. If updates are available, at 906, the updated files are downloaded to the MMCD and installed. It is to be appreciated that the downloaded files need not be installed right away, but can be installed at a later time, if the device activity is such that immediate installation will hamper existing operations. On the other hand, at 904, if no updates are available, flow can be back to 902 to again check for updates. It is to be understood that this check need not be right away, but can be at a much later time (e.g., days or weeks). Alternatively, the update component can employ a service that pushes the check-for-updates process to the MMCD devices when updates are known to be available for those particular configurations of MMCDs.

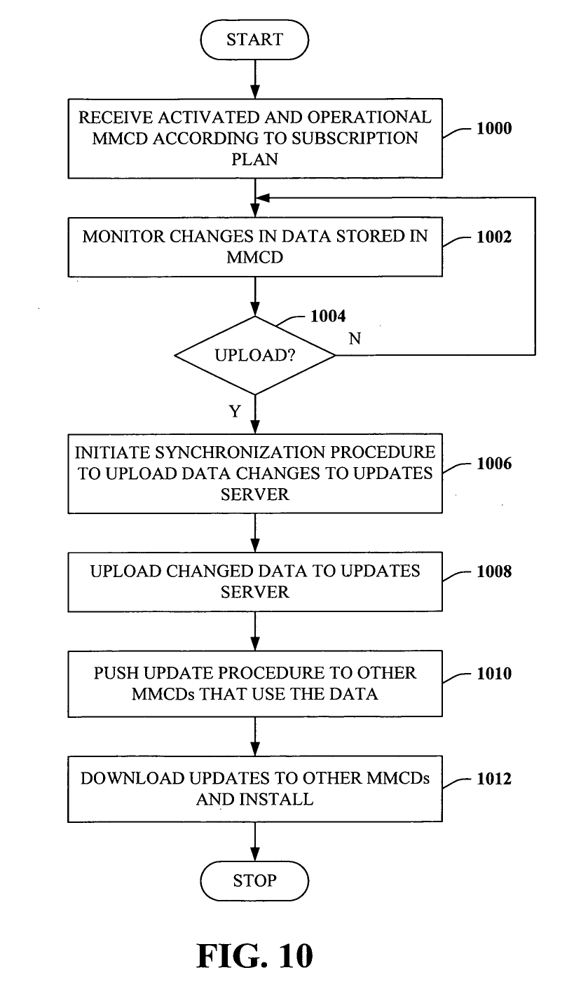

FIG. 10 illustrates a methodology of synchronizing data of an MMCD according to an aspect. At 1000, an activated and operational MMCD is received for operation under a subscription plan. At 1002, changes in data stored on the MMCD are monitored. At 1004, a check is made to determine if the changes should be synchronized with other MMCDs and/or systems. If so, at 1006, a synchronization procedure is initiated to upload the changed data to an updates server. At 1008, the changed data is uploaded to the updates server. Once the data is uploaded the synchronization process can continue for other devices. Accordingly, at 1010, an update procedure can be pushed to other MMCDs of the user that are employed in the same type of environment. For example, if the environment is a restaurant, only those MMCDs and related systems deployed in the restaurant environment will be updated. If the user has other MMCDs and related systems deployed in a different environment, those devices need not be synchronized at this time since the data could be irrelevant for them. At 1012, the updates are downloaded to the other relevant MMCDs and installed. If, on the other hand, there are no changes to the data, no upload is needed, and flow is from 1004 to 1002 to continue monitoring for changes in data of the MMCDs.

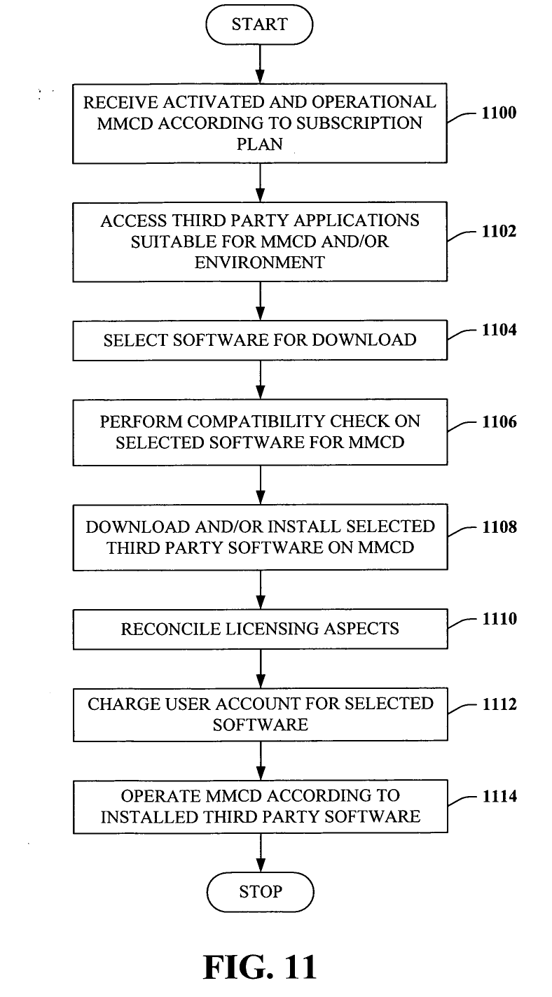

FIG. 11 illustrates a methodology of installing third-party applications according to an aspect. At 1100, an activated and operational MMCD is received under a level of service. At 1102, third-party applications suitable for an MMCD and/or other systems in the environment are accessed. The other related systems can include a wireless access point to which an MMCD communicates or a fixed external system that interacts with the MMCD during an operation, for example. At 1104, the user can select software for purchase and/or download. At 1106, a compatibility check can be initiated to ensure that the selected software is compatible with the MMCD and/or system selected for install. If the selected software is not compatible, the user can be messaged accordingly, and no software is purchased and/or downloaded. At 1108, the selected software is downloaded and/or installed on the MMCD and/or system. Although optional, at 1110, license reconciliation can be processed at this time to ensure that all aspects of licensing are proper. At 1112, the user account can be charged for any purchases made of the third-party software and/or hardware ordered for delivery. At 1114, the MMCD and/or related system can then be operated according to the installed third-party software and/or hardware. In one implementation, the software will only be activated when the purchase transaction and integrity of software has been deemed successful.

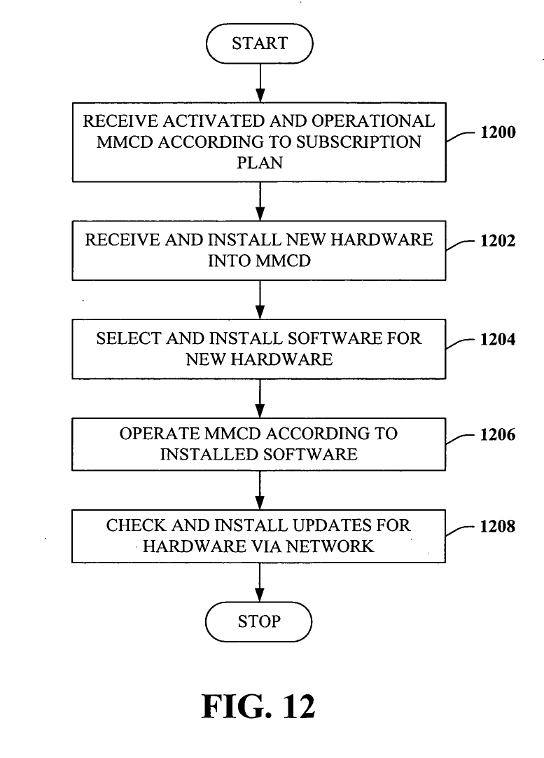

FIG. 12 illustrates a methodology of employing third-party hardware in an MMCD and/or related system according to an innovative aspect. At 1200, an activated and operational MMCD is received for operation under a level of service. At 1202, new hardware is received and installed. This can include hardware such as approved circuit boards or sensors, for example, for the MMCD and/or related systems. At 1204, software related to operation of the installed hardware can be selected and downloaded from an infrastructure network entity (e.g., third party server) for install. At 1206, the MMCD can then be operated according to the installed software (e.g., third-party software). At 1208, checks can be made for updates, and the updates installed via the network infrastructure.

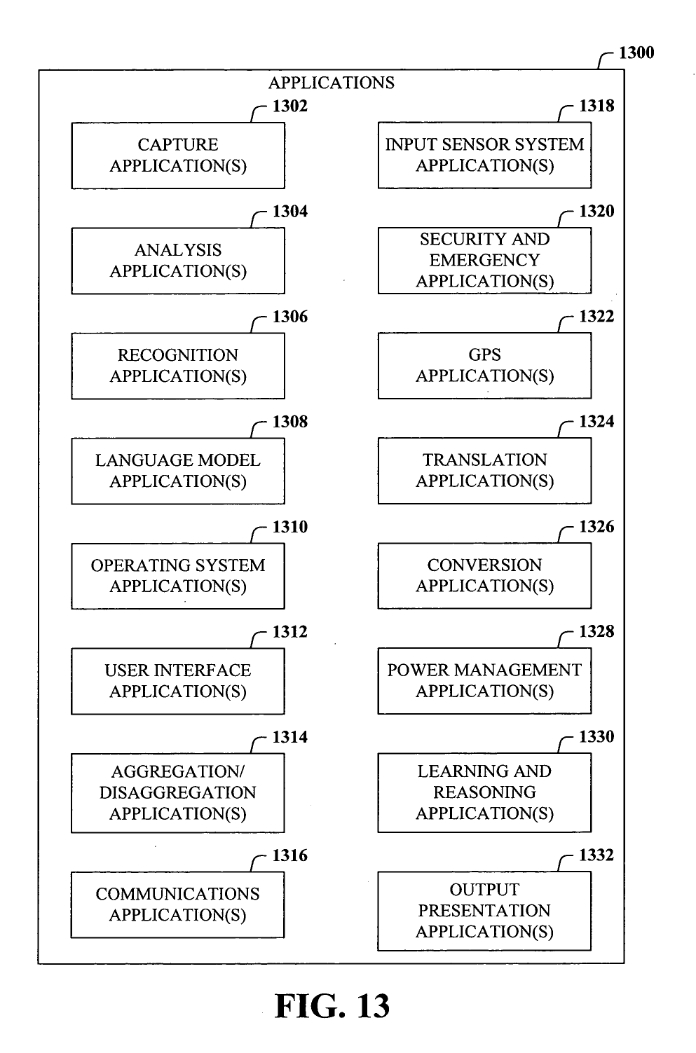

FIG. 13 illustrates a block diagram of an exemplary applications component 1300 that can provide application software in accordance with an aspect. The number and type of applications that can be provided for download and operation of an MMCD and related systems can be many, with some of the possible types of applications provided for illustrative purposes and not by limitation.

Capture application(s) 1302 can be provided that facilitate the capture of sensor information. For example, an image sensor can be operated using software that facilitate the capture of images. Similarly, capture software can be employed for controlling and managing the capture of environmental data (e.g., temperature, humidity, pressure, interital . . . ) associated with a user or device context, audio data, and speech data, to name just a few. Sensor subsystems can also include the capability to scan barcodes, read RFID (radio frequency identification) tags and other product information related to shopping and product tracking, for example.

Analysis application(s) 1304 can be provided for analysis of the captured data obtained from the capture applications 1302. Based on the results of the analysis applications, recognition applications 1306 can be provided to further analyze the data for recognition of features and characteristics of the data. For example, analysis of captured image data can be performed to determine facial features of a person captured in the image. Similarly, analysis of captured image data can be performed to determine text information via optical character recognition (OCR) of the text captured in the image. In yet another example, captured audio signals can be analyzed for speech content by a speech recognition application. These are only a few examples of the recognition software that can be employed as part of the recognition applications 1306. In another example, based on data captured via the capture applications from day-to-day habits, the analysis applications 1304 can also be utilized to feedback information to a user as to how to improve user habits for more healthful living. Other recognition applications can facilitate speech recognition, handwriting recognition, gate recognition, retinal scan recognition, thumb/hand print recognition, biometrics, and so on.

Language model applications 1308 can be provided for speech translation processes. For example, a language model that provides translation between English and German can be employed where an MMCD is utilized by an English-speaking tourist in Germany to accommodate language translation between the tourist and a native German. Other language models can be provided as desired.

Operating system (OS) applications 1310 can be provided as the basic OS of the MMCD and/or related systems. For example, the MMCD can require an OS that supports its sensor subsystems, communications, and other applications loaded thereon for operation in the user environment.

User interface (UI) applications 1312 can be provided for the MMCD and other related systems. For example, a UI for the MMCD facilitates user interaction with the MMCD and its subsystems. Similarly, a UI for can be provided for external fixed systems that work in combination with the MMCD. For example, it is within contemplation of the subject innovation that where a user approaches a security system, the MMCD can be employed to communicate information to the security system that facilitates user access. Accordingly, the security system can utilize a UI suitable for user interaction therewith, and downloadable from the novel infrastructure.

Aggregation/disaggregation applications 1314 can be provided for combination or separation of devices and/or systems. An aggregation program can be employed that facilitates the combining of two or more sensors or data inputs for determining user context or at least improving on the accuracy of determining the user context or state. For example, combining the inputs of received GPS signals (e.g., with coordinates of Pike's Peak in Colorado) with cold temperature readings (e.g., due to snow) can further aid in determining that the user context could be somewhere in the mountains. Further aggregating data from a pressure sensor (e.g., associated with the altitude known to be at Pike's Peak) enhances the likelihood that the user is at Pike's Peak in the Rocky Mountains.

In another example, aggregation applications can also find utilization for aggregating two or more MMCDs to cooperate in capturing data or presenting data. For example, the cameras of two or more MMCDs can be employed under control of an aggregation program to capture a stereoscopic or panoramic view or at least a wider view of the scene being captured.

In an aggregation implementation, multiple sensor subsystems of the MMCD can be configured to operate in a particular context to capture and receive data. A disaggregation application facilitates the selection of a reduced set of the available sensor subsystems for operation during any given environment. Similarly, where multiple MMCDs are employed in a user environment (e.g., a meeting where six user MMCD devices are aggregated for videoconferencing), a disaggregation application can facilitate the selection of fewer or total disaggregation of all MMCDs. Disaggregation applications also facilitate the operation of disparate devices, for example, a watch, earphone, batteries in shoes, cell phone, sun glasses, embedded GPS, accelerometer, PDA, camera, wired attire, etc. Devices can dynamically join or disjoin to provide optimized level of functionality and or power requirements.

In other examples of aggregation, many MMCDs can be utilized for collaborative note taking, presentation generation, and memorializing a meeting, etc. MMCDs can take on unique roles as part of a combined collaborative documentation effort. One device indexes, another collects audio data, another collects video data, another metadata, for example. Additionally, devices can aggregate disparate comments/moments into single temporal-based experience.

Aggregation applications 1314 can also be defined to include the mixing of data to create rich documents, the various types of data (e.g., text, images, graphics, audio, . . . ) fused to generate rich documents with multi-dimensional data.

Communications applications 1316 can facilitate communications of the appropriate devices and/or related systems. For example, an MMCD can require communications software for communicating with wireless access points, wired networks and the like. Similarly, communications applications 1316 also facilitate serial communications via serial communications protocols (e.g., USB, IEEE 1394, . . . ), and cellular communications over cellular networks (e.g., voice communications and messaging). In another example, cellular communications of an MMCD can be offloaded to a desktop computer when a user enters into a predetermined radio range of the computer, and thereafter returned to the MMCD when the user removes the MMCD from radio range of the computer.

These applications 1316 can also include the generation of questions and answers that can be posed to the user and/or an indigenous recipient. Such questions and answers can help reason and clarify intentions, goals, and needs from contextual clues and content.

Input sensor system applications 1318 can facilitate signal conditioning related to sensor subsystems, for example. Where environmental sensors are employed (e.g., temperature, humidity, pressure, . . . ), these applications facilitate the excitation voltages and/or currents appropriate for sensor operation and data normalization for output processing.

Security and emergency applications 1320 facilitate secure communications and secure user access to the MMCD and related systems. For example, wireless encryption protocols can be employed between the MMCD and the infrastructure networks and entities. Secure user access can also include user login processes to the MMCD apparatus, as well as authentication processes of the MMCD and/or user to one or more of the infrastructure networks and services. Emergency applications can include calling 9-1-1 services and E911 location services for locating the MMCD user.

GPS applications 1322 facilitate the receipt (along with communications applications 1316) and processing of GPS signals (e.g., coordinate processing) for at least the determination of user context.

Translation applications 1324 provide translation of data from one language to another. These applications can be used with the language model applications 1308. For example, where the user is an English-speaking tourist traveling in Germany, the chosen language model can be an English-German model which facilitates translation of English information into German, and vice versa.

Conversion applications 1326 can include providing conversion of data from one format to another. That is, conversion can include text-to-speech, speech-to-speech, speech-to-text, text-to-text, graphic data to associated text and/or speech, text-to-image, and so on. Continuing with the tourist example, if the English tourist speaks into the MMCD, the output can be in German, as text. Thus, translation is from English to German and conversion is from English speech to German text.

Power management applications 1328 facilitate control and management of power to subsystems of the MMCD and/or related systems. These applications 1328 can include the charging of battery subsystems and the presentation of charging information via the UI applications 1312. The power management applications 1328 also provide for selective power savings by powering down after a predetermined period of time of subsystems that are not being utilized. This can include placing one or more subsystems in a standby mode, or powering down the associated subsystems, entirely, and then enabling power to the subsystems when required and taking the systems from a standby mode to an online mode when required.

Machine learning and reasoning (MLR) applications 1330 can provide for automating one or more features in accordance with the subject innovation. The subject invention (e.g., in connection with selection) can employ various MLR-based schemes for carrying out various aspects thereof. For example, a process for determining updates should be performed can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed. In the case of data and speech processing systems, for example, attributes can be words or phrases or other data-specific attributes derived from the words (e.g., database tables, the presence of key terms), and the classes are categories or areas of interest (e.g., levels of priorities).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions, including but not limited to determining according to a predetermined criteria when to synchronize data between MMCDs and/or network entities, when to install previously downloaded updates, when and how to aggregate or disaggregate MMCD subsystems and/or multiple MMCDs, what language models to employ, what conversion techniques should be employed based on the user environment, and so on.

Output presentation applications 1332 provide for the presentation of data in many different formats. For example, input speech can be output as audio voice signals, text can be output as speech signals and/or presented on a display, input speech can be output as text signals that are presented on the MMCD display, and so on.

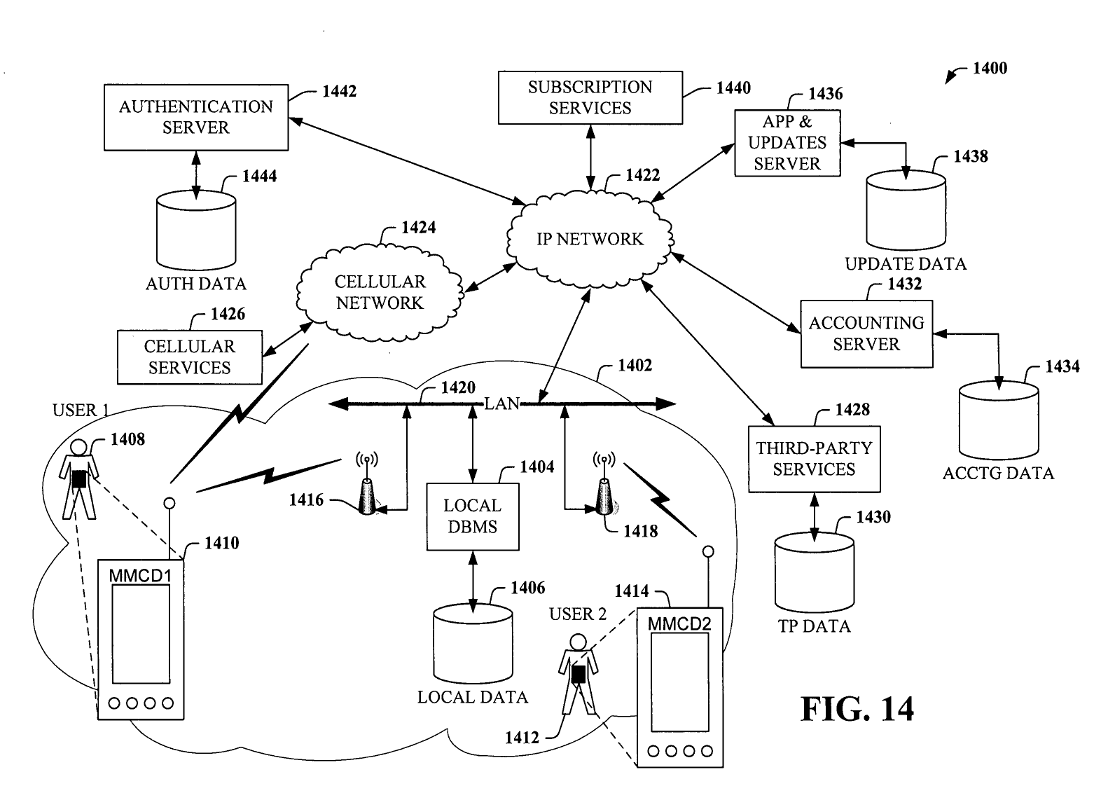

FIG. 14 illustrates an exemplary infrastructure 1400 that facilitates MMCD communications and deployment in a local environment in accordance with an innovative aspect of the invention. Here, one or more MMCDs can be employed in a relatively local environment 1402 (e.g., a restaurant). The local environment 1402 can include a local database management system (DBMS) 1404 and associated local datastore 1406 for storing data. A first user 1408 can carry a first MMCD 1410 (denoted MMCD1) and a second user 1412 can carry a second MMCD 1414 (denoted MMCD2). The first MMCD 1410 and second MMCD 1414 can register and communicate with a first wireless access point 1416 and a second wireless access point 1418 when brought into radio range of the access points (1416 and 1418). The access points (1416 and 1418) are disposed on a LAN 1420 such that the MMCDs (1410 and 1414) can access and upload data to the DBMS 1404. Additionally, the users (1408 and 1412) can access data and/or services of the LAN 1420 via the devices (1410 and 1414).

In one implementation, and as described supra, as the first user device 1410 receives data that can be useful to the second user 1412, and vice versa, the devices (1410 and 1414) can synchronize data such that both devices (1410 and 1414) have substantially the same data. For example, user interaction with a restaurant customer by the first user 1408 can be communicated to the second device 1414 such that if the second user 1412 needs to communicate with the customer, the data is already available for use by the second user 1412. This can be accomplished using only the local LAN 1420 and/or can be facilitated via a remote network of the infrastructure.

The infrastructure 1400 can also include a remote IP network 1422 (e.g., the Internet) that can provide IP services and a cellular network 1424 that can provide cellular services 1426. As indicated supra, services that can be provided via the IP network 1422 include third-party services 1428 associated with a third-party (TP) datastore 1430, accounting services 1432 associated with an accounting datastore 1434, application and update services 1436 associated with an update and applications datastore 1438, subscription services 1440, and authentication services 1442 associated with an authentication datastore 1444.

As described supra, the first MMCD 1410 can connect to services provided by the IP network 1422, and to cellular services 1426 provided by the cellular network 1424. The first MMCD 1410 can also communicate with the cellular network 1424 to access services 1426 provided thereon.

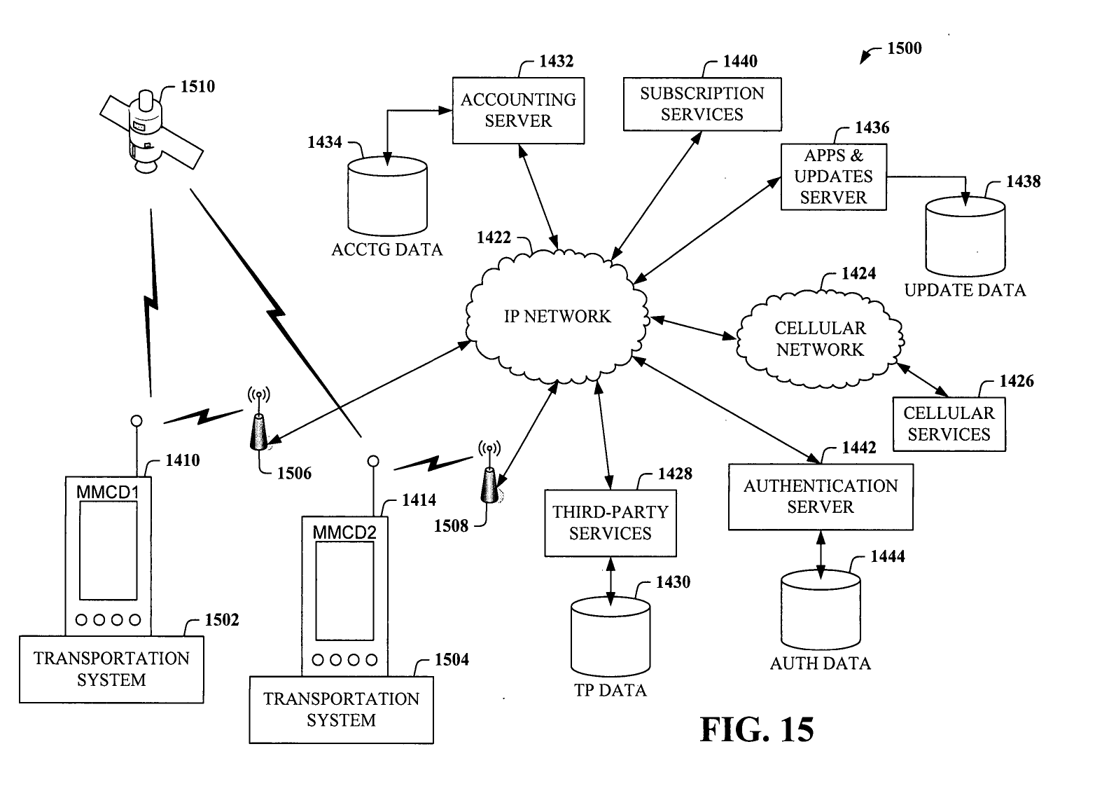

FIG. 15 illustrates an exemplary infrastructure 1500 that facilitates MMCD communications and deployment in a more expansive environment in accordance with an innovative aspect of the invention. Here, the MMCD devices (1410 and 1414) can be deployed in transportation systems, for example, the first MMCD 1410 can be deployed in a first transportation system 1502 (e.g., a first taxi cab) and the second MMCD 1414 can be deployed in a second transportation system 1504 (e.g., a second taxi cab). Network access to the IP network 1422 can be obtained via first and second access points (1506 and 1508). The first and second devices (1410 and 1414) can also communicate directly with the cellular network 1424 and its services 1426.

As indicated supra, services that can be provided via the IP network 1422 include third-party services 1428 associated with the third-party datastore 1430, accounting services 1432 associated with the accounting datastore 1434, application and update services 1436 associated with the update and applications datastore 1438, subscription services 1440, and authentication services 1442 associated with the authentication datastore 1444.

Here, the devices (1410 and 1414) can also receive GPS signals from a GPS satellite system 1510. Thus, as the transportation systems (1502 and 1504) move around, the associated MMCDs (1410 and 1414) can be tracked. In one implementation, the geographic location of a device can be the trigger that initiates synchronization between the devices (1410 and 1414).

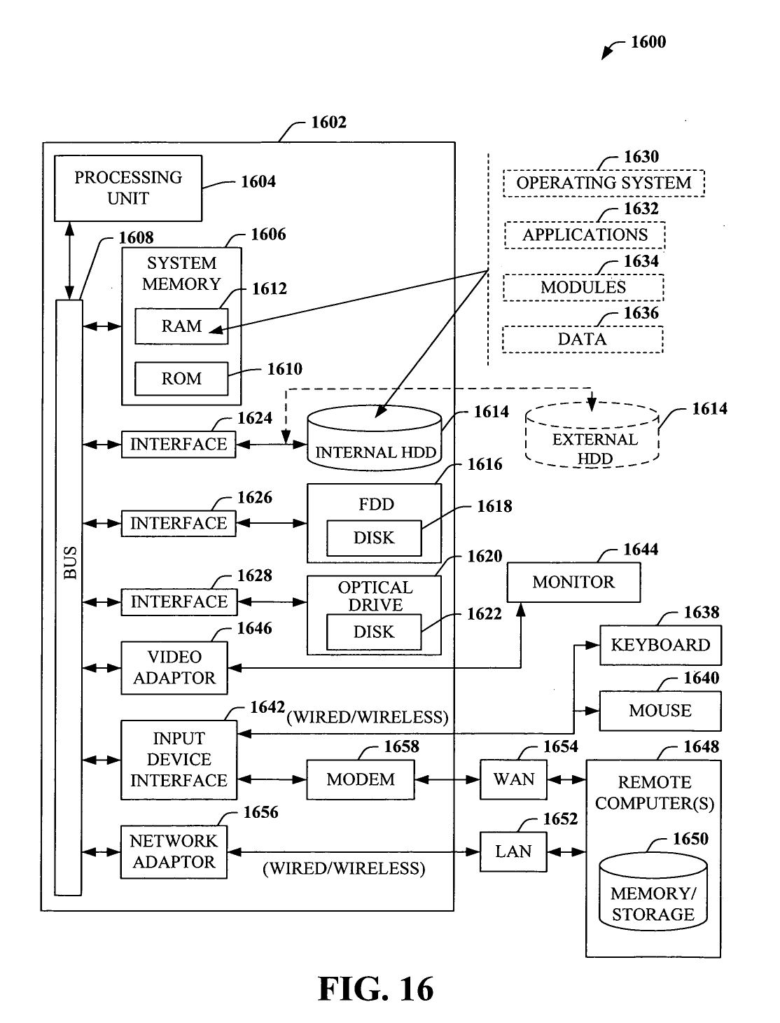

Referring now to FIG. 16, there is illustrated a block diagram of a computer operable to execute the disclosed architecture. In order to provide additional context for various aspects thereof, FIG. 16 and the following discussion are intended to provide a brief, general description of a suitable computing environment 1600 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 16, the exemplary environment 1600 for implementing various aspects includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g, reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is to be appreciated that the innovation can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which may connect to a global communications network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b ) data rate, for example, or with products that contain both bands (dual band), so the networks can provide real-world performance similar to the basic 10BaseT wired Ethernet networks used in many offices.

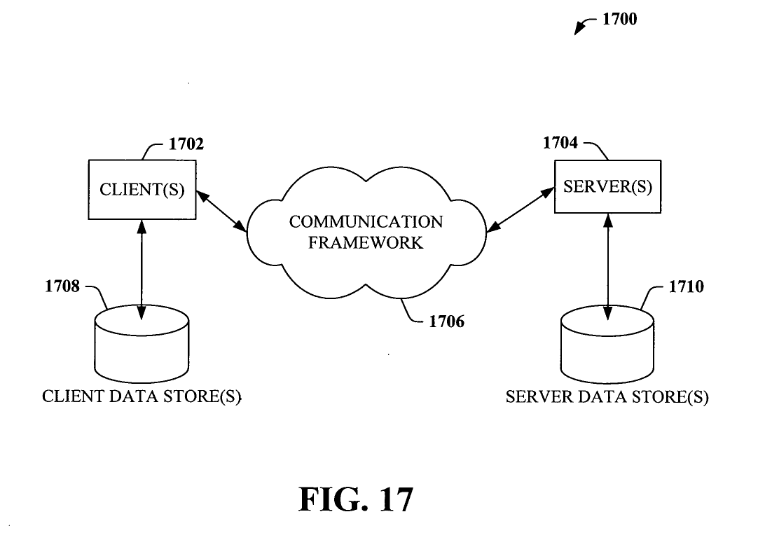

Referring now to FIG. 17, there is illustrated a schematic block diagram of an exemplary computing environment 1700 in accordance with another aspect. The system 1700 includes one or more client(s) 1702. The client(s) 1702 can be hardware and/or software (e.g., threads, processes, computing devices). The client(s) 1702 can house cookie(s) and/or associated contextual information by employing the subject innovation, for example.

The system 1700 also includes one or more server(s) 1704. The server(s) 1704 can also be hardware and/or software (e.g., threads, processes, computing devices). The servers 1704 can house threads to perform transformations by employing the invention, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An infrastructure for a multi-modal multilingual communications device, comprising:
a communications component that facilitates communications between the multi-modal multilingual communications device and another entity; and
a management component that communicates services to the multi-modal multilingual communications device via the communications component.

2. The infrastructure of claim 1, wherein the communications component includes a cellular network for cellular communications and an IP network for packet communications such that the multi-modal multilingual communications device can communicate over the cellular network and the IP network to access services disposed thereon.

3. The infrastructure of claim 1, further comprising an access component that facilitates access to entities of the management component and the communications component.

4. The infrastructure of claim 3, wherein the access component includes a web server via which a user can log-in and access the entities.

5. The infrastructure of claim 1, wherein the management component includes a synchronization component that facilitates synchronization of data between the multi-modal multilingual communications device and at least one of another multi-modal multilingual communications device and a network.

6. The infrastructure of claim 1, wherein the management component includes a subscription component that tracks and stores user subscription information related to levels of service under which the multi-modal multilingual communications device operates.

7. The infrastructure of claim 1, wherein the management component includes an activation component that activates the multi-modal multilingual communications device for operation over a cellular network and an IP network.

8. The infrastructure of claim 1, wherein the management component includes an authentication component that authorizes or denies access of the multi-modal multilingual communications device to at least one of a cellular network and an IP network.

9. The infrastructure of claim 1, wherein the management component includes an update component that pushes software updates to the multi-modal multilingual communications device via the communications component.

10. The infrastructure of claim 1, wherein the management component includes an accounting component that tracks usage of the multi-modal multilingual communications device and facilitates charging an account according to a level of subscribed services.

11. The infrastructure of claim 1, wherein the management component includes an applications component that facilitates the download and installation of an application on the multi-modal multilingual communications device.

12. The infrastructure of claim 1, wherein the management component includes a third-party services component that facilitates the download and installation of third-party software and services to the multi-modal multilingual communications device.

13. The infrastructure of claim 1, further comprising a machine learning and reasoning component that employs a probabilistic and/or statistical-based analysis to prognose or infer an action that a user desires to be automatically performed.

14. A method of managing services for a multi-modal multilingual communications device via a communications infrastructure, comprising:
authenticating the device for access to a cellular network and an IP network;
activating the device for operation over the cellular network and the IP network;
accessing subscription information associated with the device and according to which the device is allowed to operate;
updating software of the device by downloading the software from the IP network;
tracking operational usage of the device; and
synchronizing data of the device with another multi-modal multilingual communications device.

15. The method of claim 14, further comprising an act of providing third-party services and software for utilization by the device.

16. The method of claim 14, further comprising an act of automatically upgrading the device to a new subscription level based on excessive usage.

17. The method of claim 14, further comprising an act of configuring the device for use in a particular environment by enabling one or more device functions and disabling one or more other device functions.

18. The method of claim 14, wherein the act of synchronizing is performed between devices that are deployed in a same environment.

19. The method of claim 14, further comprising an act of performing a compatibility check of the software and the device before performing the act of updating.

20. A communications and services infrastructure for a multi-modal multilingual communications device, comprising:
computer-implemented means for authenticating the device for access to a cellular network and an IP network;
computer-implemented means for activating the device for operation over the cellular network and the IP network;
computer-implemented means for accessing subscription information associated with the device and according to which the device is allowed to operate;
computer-implemented means for updating software of the device by downloading the software from the IP network;
computer-implemented means for tracking operational usage of the device; and
computer-implemented means for synchronizing data of the device with another multi-modal multilingual communications device.
